(19) United States
(12) Patent Application Publication
(10) Pub. No.: US 2026/0129118 A1
(43) Pub. Date: May 7, 2026

(54) METHOD AND SYSTEM FOR DETECTING SCAMS IN TELEPHONE COMMUNICATIONS

(71) Applicant: Veriswitch Solutions Inc., Cheyenne, WY (US)

(72) Inventor: Umberto Mautone, Blainville (CA)

(73) Assignee: Veriswitch Solutions Inc., Cheyenne, WY (US)

(21) Appl. No.: 18/940,526

(22) Filed: Nov. 7, 2024

(51) Int. Cl. H04M 3/22

(52) U.S. Cl. CPC H04M 3/2281; H04M 2203/30; H04M 2203/6027

(57) ABSTRACT

A system for detecting scams in telephone communications including a switch platform in communication with a originating entity and a receiving entity, the switch platform being configured to route a telephone call from the originating entity to the receiving entity, the originating entity is an originator of the telephone call and the receiving entity is a recipient of the telephone call, the switch platform being configured to receive a plurality of telephone calls; a fraud detection system in communication with the switch platform, the fraud detection system being configured to receive a re-routed audio portion of selected one or more telephone calls; and an artificial intelligence engine in communication with the fraud detection system, the artificial intelligence engine being configured to analyze a sample of the re-routed audio portion to determine whether the selected one or more telephone calls is a scam telephone call.

### BACKGROUND

The field of the currently claimed embodiments of this invention relates generally to telephone communications, and more specifically to a method and a system for detecting fraud, scams and fraudsters in telephone communications.

Unlawful, fraudulent, and scam activity can occur in telephone communications (e.g., telephone calls) by leading non-suspecting individuals to provide personal and financial information to fraudsters. Telephone fraud and scams are increasingly common. This type of activity may cause significant financial cost and emotional distress to its victims. For example, a recipient of a scam telephone communication may be tricked into providing information leading to identity theft and/or gaining access to bank accounts, or financial information or money for paying for products or services that will not be fulfilled. Telephone communication scammers are increasingly exploring various ways to deceiving non-suspecting victims. For example, telephone scams may originate from different countries, making it very difficult for telephone companies to track the origin of the telephone calls.

Detecting or preventing scams is increasingly difficult. For example, existing methods may not be able to detect scammers that evade detection by spoofing telephone numbers, changing telephone numbers, and using spoofed numbers that correspond to the geographical area of the targeted non-suspecting individual. The ability to detect fraud over telecommunication networks provides telecommunication carriers with an opportunity to mitigate the risk or severity of damage.

### BRIEF DESCRIPTION OF THE DRAWINGS

The present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

FIG. 1 is a diagram of a system for detecting scams in telephone communications, according to an embodiment of the present invention.

FIG. 2 shows an example of a report showing the detection of the presence of a scam telephone call, according to an embodiment of the present invention.

FIG. 3 shows an example of a suspicious call report (“SCR”), according to an embodiment of the present invention.

FIG. 4 shows an example popup window that is displayed when a network from which a telephone scam originated is blocked, according to an embodiment of the present invention.

FIG. 5 is a diagram of a computer system used to implement the system and method for detecting scams in telephone communications, according to an embodiment of the present invention.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention.

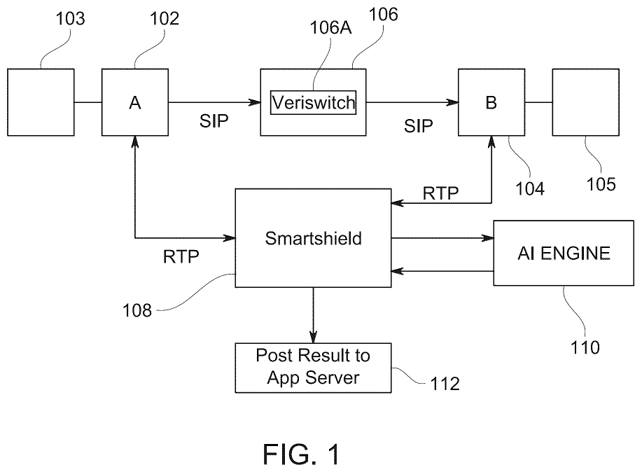

FIG. 1 is a diagram of a system for detecting scams in telephone communications, according to an embodiment of the present invention. As shown in FIG. 1, a telephone call(s) is/are routed from an originating entity 102 (e.g., customer A) to a receiving entity 104 (e.g., vendor B). Therefore, the originating entity 102 may be considered the originator of the telephone call and the receiving entity 104 may be considered the receiver of the telephone call. Normally, the audio (Real Time Protocol or RTP) from the telephone call will flow between the originating entity 102 and receiving entity 104 directly or through a proxy. The originating entity 102 can be a carrier, such as AT&T, a wholesaler, or an enterprise user. The receiving entity 104 can also be a carrier, such as Verizon, a wholesaler, or an enterprise user. In an embodiment, the originating entity 102 may be in communication with a source entity 103 which can be a carrier, a wholesaler, or an enterprise user. The receiving entity 104 may also be in communication with a forward entity 105 which also can be a carrier, a wholesaler, or an enterprise user. For example, a call may originate from the source entity 103 that is transmitted to the originating entity 102 which then forwards the call to the intermediate entity 106 who transmits the call to the receiving entity 104. The receiving entity 104 may further transmit the telephone call to the forward entity 105. Therefore, the term “originating entity” is not limited to an entity from which a telephone call originates. Similarly, the term “receiving entity” is not limited to the ultimate recipient of the telephone call. The flow shown in FIG. 1 may be several links in a larger, overall call flow.

In an embodiment, the telephone call from the originating entity 102 to the receiving entity 104 may pass through an intermediate entity 106 (e.g., a transit carrier, a reseller reselling to their carrier, etc.). The intermediate entity 106 has a switch platform 106A. The telephone call from the originating entity 102 can itself originate from the source entity 103. The switch platform 106A in the intermediate entity 106 (e.g., transit carrier) routes the telephone call from the originating entity 102 to the receiving entity 104. In an embodiment, the telephone call can be completed through a Session Initiation Protocol (SIP) or Voice Over Internet Protocol (VoIP). Other mechanisms for completing the call are also contemplated. SIP handles all types of media including voice and messages through the internet. The switch platform 106A in the intermediate entity 106 can include, for example, a computer system. In an embodiment, the switch platform 106A can include a switching software program that runs on the computer system. The switch platform 106A can also reside on the cloud.

In an embodiment, the switch platform 106A in the intermediate entity 106 receives a plurality of telephone calls (e.g., thousands of telephone calls per second) from various users from the originating entity 102 and selects one or more telephone calls in the plurality of telephone calls and re-routes the audio portion of the selected one or more telephone calls (i.e., the audio portion of the one or more telephone calls) to a fraud detection system 108. A telephone call may contain, in addition to the audio portion, call metadata that may include time of the call is made, the duration of the call, caller's telephone number, and call recipient's telephone number. In exemplary embodiments, signaling associated with the call may in flow through each hop. The intermediate entity 106 can be a carrier, or reseller, reselling to their carrier or end-user customers and routing calls to their carrier vendors. For example, intermediate entity (e.g., transit carrier) 106 sells to originating entity 102 and buys from receiving entity 104. For example, the intermediate entity 106 may receive ten million (10,000,000) telephone calls per day that are processed through the switch platform 106A. Many carrier customers such as intermediate entity 106 may use the switch platform 106A. Each customer may receive a certain amount of telephone calls.

In an example, among the telephone calls received by the intermediate entity 106, for example, 10 million (10,000,000) calls, the switch platform 106A randomly samples a subset of those call, for example about 800 telephone calls, to be sent for analysis by the fraud detection system 108. In practice, the majority of the ten million telephone calls may not connect. For example, only 2.9 million of the telephone calls placed may be connected. In addition, for most of the connected telephone calls, the average telephone call length can be about 20 seconds or less which may not be sufficient for analysis by the fraud detection system 108. Out of the 2.9 million telephone call that are connected, the switch platform 106A in the intermediate entity 106 may only randomly sample about 600 to 800 telephone calls that may have sufficient telephone call length (for example, more than 30 seconds) to be routed or sent for analysis by the fraud detection system 108. In an embodiment, a sampling ratio of telephone calls may average less than one percent (1%) of a total call volume. In an example, the telephone calls that are routed to the fraud detection system 108 may be randomly selected from the 2.9 million connected calls, or from a subset of those telephone calls that have sufficient duration and content for analysis.

The fraud detection system 108 is in communication with the switch platform 106A in the intermediate entity 106. In an embodiment, the fraud detection system 108 can be a separate system from the switch platform 106A. In another embodiment, the fraud detection system 108 can integrated and be an integral part of the switch platform 106A (e.g., Veriswitch platform or other network platforms). The fraud detection system 108 is configured to receive the audio portion of the selected one or more telephone calls (e.g., 600 to 800 telephone calls) by the switch platform 106A. In an embodiment, the signaling of the telephone call originating from the originating entity 102 remains within the switch platform 106A and only the audio portion of the telephone call, i.e., the Real Time Protocol (RTP), from the originating entity 102 is routed to fraud detection system 108. In an embodiment, the signaling of the telephone call may include, for example, metadata of the telephone call.

In an embodiment, the fraud detection system 108 samples the audio portion of the telephone call originating from the originating entity 102 (e.g., the originator of the telephone call). In an embodiment, the fraud detection system 108 does not sample the audio portion originating from the receiving entity 104 (i.e., receiver of the telephone call). Generally, the “A” leg of a telephone call represents the incoming call leg to a switch, while the “B” leg represents the outgoing call from the switch. In most cases, the originator of the call is the “A” leg, and the recipient of the call is the “B” leg. Therefore, the fraud detection system 108 only samples the “A” leg audio portion of the telephone call and does not sample the “B” leg audio portion of the telephone call. Thus, the fraud detection system 108 is not eavesdropping on the entire telephone conversation between the originating entity 102 (e.g., originator of the telephone call) and the receiving entity 104 (receiver of the telephone call).

The fraud detection system 108 may only sample the audio portion of the telephone call from the originating entity 102 to the receiving entity 104. The fraud detection system 108 may only monitor the context of the caller or the originator of the telephone call which in this case is the originating entity 102. In an embodiment, the fraud detection system 108 samples the telephone call from the originating entity 102 during a selected time period T to extract a sample of the audio portion of the telephone call from the originating entity 102 to the receiving entity 104. The time period T can be from one half of a minute to four minutes, for example up to three minutes. The time period T can be a portion of a total duration of the telephone call, or the total call time. The time period T is selected to be sufficient to gather the context of the telephone call from the originating entity 102 to the receiving entity 104. The fraud detection system 108 is configured to transcribe to text of at least a portion of the sample of the telephone call from the originating entity 102 to the receiving entity 104 (“A” leg of the call).

The transcribed at least portion of the sample of the telephone call is transmitted to the Artificial Intelligence (AI) engine 110 in communication with the fraud detection system 108 for analysis of the transcribed at least portion of the sample of the telephone call. The AI engine 110 then returns a result of the analysis of the transcribed at least portion of the sample of the telephone call to the fraud detection system 108. In an embodiment, the AI engine 110 can be located external to the fraud detection system 108. In another embodiment, the AI engine 110 can be located and provided within or as an integral part of the fraud detection system 108. The AI engine 110 may use a machine learning (ML) algorithm that is trained with training data to look for certain queues such as behavioral queues or a pattern in a call to assess a probability or score of a scam telephone call.

The fraud detection system 108 uses the AI engine 110 to monitor the telephone communication for context, behavioral patterns, purpose of the call, quality of language, grammar, and content to determine the probability of telephone call having fraudulent potential. The AI engine 110 may operate in several languages, including mixed language calls. The fraud detection system 108 gathers data in a telephone call path without interfering in the completion of the telephone call. In an embodiment, the AI engine 110 can use a large language model (LLM) (e.g., an LLM from OpenAI).

The training data to train the ML algorithm (e.g., LLM) can be observed telephone calls that are known fraudulent or scam telephone calls. The training data may not be strictly based on selected keywords as keywords may not be reliable indicators of scams. Instead, the training data may be based on overall speech key indicators. For example, when a telephone caller calling through the origination entity 102 is trying to confirm an order they allegedly placed and does not mention a name of a recipient receiving the telephone call through the receiving entity 104, the ML algorithms may raise the probability of the presence of scam by a certain amount. In another example, bad grammar in the telephone call can also be used as an indicator of the presence of a scam in a telephone call. In an embodiment, the key indicators may or may not be weighted in the ML algorithm.

When the AI engine 110 using the ML algorithm detects the presence of a scam in a telephone call. The AI engine 110 returns a probability of the presence of a scam in a telephone call to the fraud detection system 108. The fraud detection system 108 will then send or post a report to an application server 112 of the customer using the services of the switch platform 106 (e.g., Veriswitch platform or other network platforms) and the fraud detection system 108.

The fraud detection system 108 generates an analysis of the sampled telephone calls. The analysis may have detail including a probability score, a title summarizing the telephone call's intent, the mentioned calling entity, the detected language, and a detailed explanation of how the AI engine 110 reaches its conclusion with notes to key points in the telephone call. With the analysis complete, the fraud detection system 108 may post the report containing the analysis to an application server available to the carrier. The report may be presented in other ways as well, such as a document delivered via email, a display on a screen, etc.

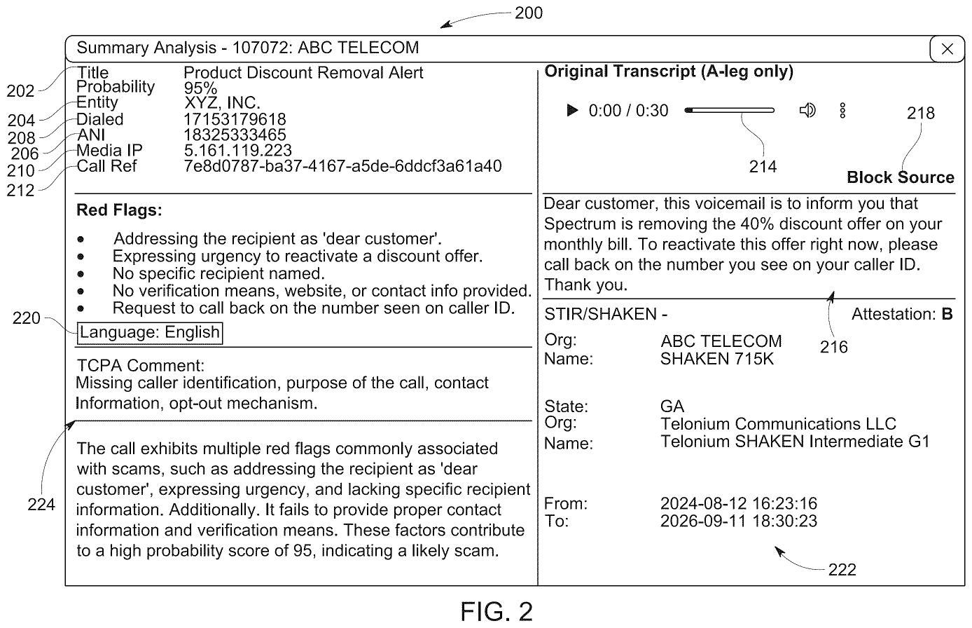

FIG. 2 shows an example of a report showing the detection of the presence of a scam telephone call, according to an embodiment of the present invention. The report 200 shown is an example administrative report made available to users of the fraud detection system 108. The report 200 contains a transcript of the A-leg of the telephone call, the call audio (A-leg only), a detailed analysis of the scam, the STIR/SHAKEN attestation information, and TCPA comments noting missing elements for compliance with TCPA. A “STIR/SHAKEN attestation” refers to a digital verification process within the STIR/SHAKEN framework where a phone service provider confirms the legitimacy of a caller's phone number by assigning an “attestation level” (A, B, or C) to each call, signifying how confident is the phone service provider that the caller is who they claim to be, essentially combating caller ID spoofing and robocalls. This is done by digitally signing the call information with a certificate, allowing receiving carriers to verify the authenticity of the call source. “TCPA” (Telephone Consumer Protection Act) is a law that regulates the use of automated calls, texts, and faxes for marketing purposes. It establishes guidelines to protect consumers from unsolicited telemarketing practices by requiring businesses to obtain prior consent before contacting individuals through these communication methods. The TCPA also sets restrictions and requirements on the use of prerecorded messages and auto-dialing systems.

The report 200 contains a title 202 describing the content, the name of the purported entity 204, the originating number 206, called or dialed number 208, links to information on the media IP address 210, the actual call detail record 212 for more detail on the telephone call, the original audio 214, a transcription of the first three (3) minutes of the A-leg audio 216, and a link 218 to block the source of the call, thus preventing any future calls from that source from re-entering the network through another trunk or customer. The text transcription is performed in the English language as shown at 220. However, the ML algorithm can operate in other languages, including, Chinese, French, Spanish, etc. The example report 200 further contains, in addition to transcript of the A-leg of the telephone call 216, a STIR/SHAKEN attestation information 222, and TCPA comments 224.

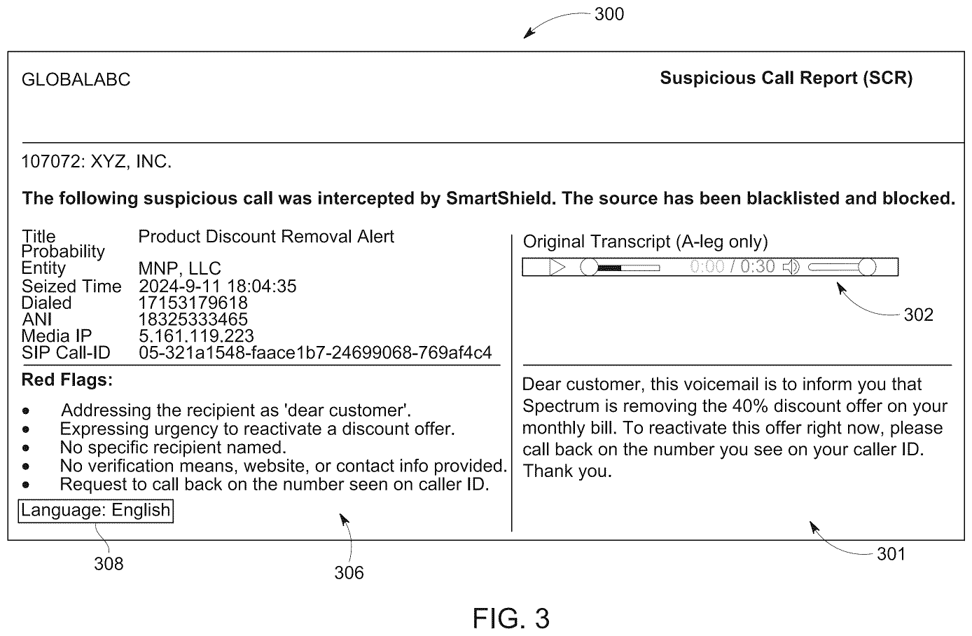

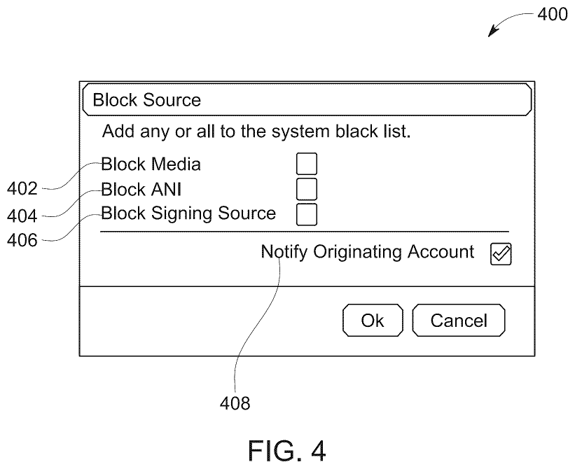

FIG. 3 shows an example of a suspicious call report (“SCR”), according to an embodiment of the present invention. The SCR can take the form of an email notification sent from the fraud detection system 108 to the customer, in this case the originating entity, via email notifying that a suspicious call was intercepted with information on the call, including the call audio. When a scam is reported (as shown in FIG. 2), the intermediate entity 106 having the switch platform 106A that employs the fraud detection system 108 can optionally try to block any further calls into their network from this campaign at the source by clicking “Block Source”218 (shown in FIG. 2). As a result, a popup 400 shown in FIG. 4, is displayed.

FIG. 4 shows an example popup window that may be displayed when a network from which a telephone scam originated is blocked, according to an embodiment of the present disclosure. From the popup 400, the intermediate entity 106 with the switch platform 106A implementing the fraud detection system 108 can block the call's media IP (RTP audio source) 402, the ANI (caller ID) 404, or the signing source 406 (the OCN of the carrier that provided the stir/shaken attestation for this call). When “Notify Originating Account” 408 is checked, an email with the Suspicious Call Report (SCR) 300 (shown in FIG. 3) is sent to the account that this call came from on the network, i.e., originating entity 102.

Carriers and other entities may use the results of the SCR 300 to act manually or automatically blacklisting the originating number, the originating media, or closing the customer's trunk altogether. The SCR 300 may be sent by the fraud detection system 108 to the originating entity 102. The SCR 300 includes the identifying information sections as described above with respect to FIG. 2. Therefore, a description of the identifying information sections shown in FIG. 2 will not be repeated here with respect to FIG. 3. In addition to the identifying information sections, the SCR 300 also includes the audio portion 302 of the telephone call, a transcript section 304 of the audio portion 302, and an analysis section 306 of the audio portion 302. The text transcription is performed in the English language as shown at 308. However, the ML algorithm can operate in other languages, including, but not limited to, Chinese, French, Spanish, etc.

The blocking option or link 218 shown FIG. 2 allows blocking of the originating phone number (ANI), the originating RTP, and/or the STIR/SHAKEN entity that signed the call, as described above with reference to FIG. 4. In an embodiment, when blocking the telephone call, the fraud detection system 108 may include the RTP Internet Protocol (“IP”) address, ANI, and OCN (operating carrier number) of the entity that authenticated the call with STIR/SHAKEN to a system blacklist and any future calls from any of these sources are immediately rejected with a SIP 608 message, preventing any future scam or suspected fraud calls to originate from any of these sources to terminate.

The fraud detection system 108 does not interfere with, divert, or reroute the telephone calls. A call flowing through the fraud detection system 108 routes through the switch platform 106 to terminate properly similar to any other regular telephone call. In an embodiment, analyzing the audio portion of the telephone call for the first three (3) minutes, for example, provides the fraud detection system 108 with the opportunity to analyze telephone calls, capture interactions with live agents, and ferret out telephone calls using diversionary tactics. For example, such tactics may include opening the call with one purpose (e.g., a poll or a survey) then transferring to a live agent and continuing with an unrelated scam (e.g., as illustrated in FIG. 3).

The use of the fraud detection system 108 assists to curb illegal, fraudulent, or harmful activity on telecommunication networks by using a ML algorithm limiting the amount of sampling to avoid collecting or reviewing more communications content than necessary. The fraud detection system 108 narrows calls under review by discarding non-commercial calls with no apparent marketing or fraudulent purpose and by using the AI engine 110 running a ML algorithm to identify unlawful robocall activity.

Detecting or identifying fraud on telecommunication networks provides carriers with an opportunity to mitigate the risk or severity of damage. By including the fraud detection system 108 in the call path, the AI engine 110 in communication or integrated within the fraud detection system 108 can detect unlawful activity from limited samplings of carrier traffic routed by the carrier when the presence of unlawful customer activity is suspected.

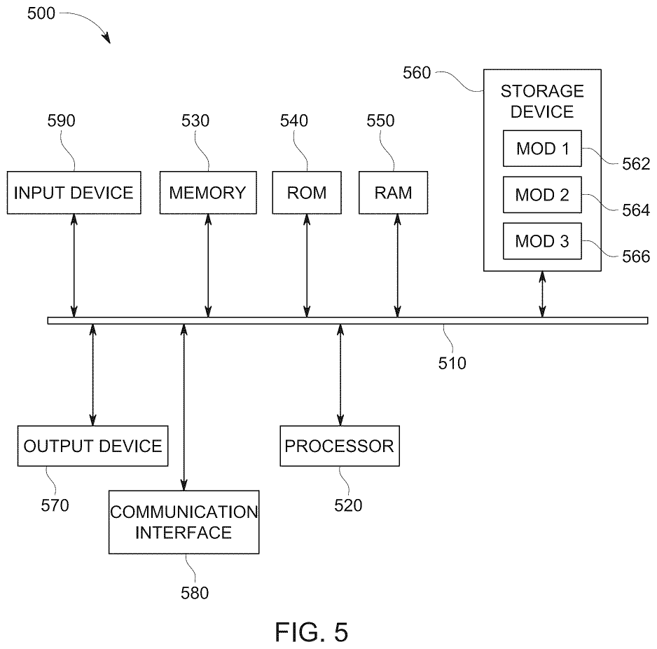

FIG. 5 is a diagram of computer system to implement the system and method for detecting scams in telephone communications, according to an embodiment of the present invention. With reference to FIG. 5, an exemplary computer system includes a general-purpose computing device 500, including a processing unit (computer processing unit-CPU and/or a graphical processing unit-GPU) 520 and a system bus 510 that couples various system components including the system memory 530 such as read-only memory (ROM) 540 and random access memory (RAM) 550 to the processor 520. The computer system 500 can include a cache of high-speed memory connected directly with, in close proximity to, or integrated as part of the processor 520. The computer system 500 copies data from the memory 530 and/or the storage device 560 to the cache for quick access by the processor 520. In this way, the cache provides a performance boost that avoids processor 520 delays while waiting for data. These and other modules can control or be configured to control the processor 520 to perform various actions. Other system memory 530 may be available for use as well. The memory 530 can include multiple different types of memory with different performance characteristics.

It can be appreciated that the disclosure may operate on a computing device 400 with more than one processor 520 or on a group or cluster of computing devices networked together to provide greater processing capability. The processor 520 can include any general-purpose processor and a hardware module or software module, such as module 562, module 564, and module 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in ROM 540 or the like, may provide the basic routine that helps to transfer information between elements within the computing device 500, such as during start-up. The computing device 500 further includes storage devices 560 such as a hard disk drive, a magnetic disk drive, an optical disk drive, tape drive, network attached storage (NAS), or the like. The storage device 560 can include software modules 562, 564, 566 for controlling the processor 520. Other hardware or software modules are contemplated. The storage device 460 is connected to the system bus 510 by a drive interface. The drives and the associated computer-readable storage media provide nonvolatile storage of computer-readable instructions, data structures, program modules and other data for the computing device 500. In one aspect, a hardware module that performs a particular function includes the software component stored in a tangible computer-readable storage medium in connection with the necessary hardware components, such as the processor 520, bus 510, display 570, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 500 is a small, handheld computing device, a desktop computer, or a computer server.

Although the exemplary embodiment described herein may employ the hard disk 460 as the storage device, other types of computer-readable media which can store data that are accessible by a computer, such as magnetic cassettes, flash memory cards, digital versatile disks, cartridges, random access memories (RAMs) 550, and read-only memory (ROM) 540, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 570 can also be one or more of a plurality of output mechanisms known to those of skill in the art. In some instances, multimodal systems enable a user to provide multiple types of input to communicate with the computing device 500. The communications interface 580 generally governs and manages the user input and system output. There is no restriction on operating on any hardware arrangement and therefore the basic features here may easily be substituted for improved hardware or firmware arrangements as they are developed.

The embodiments illustrated and discussed in this specification are intended only to teach those skilled in the art how to make and use the invention. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

We claim:

1. A system for detecting scams in telephone communications comprising:
an intermediate entity having a switch platform in communication with an originating entity and a receiving entity, the switch platform being configured to route a telephone call from the originating entity to the receiving entity, the originating entity being an originator of the telephone call and the receiving entity being a recipient of the telephone call, the switch platform being configured to receive a plurality of telephone calls;
a fraud detection system in communication with the switch platform, the fraud detection system being configured to receive a re-routed audio portion of selected one or more telephone calls from the plurality of telephone calls; and
an artificial intelligence engine in communication with the fraud detection system, the artificial intelligence engine being configured to analyze a sample of the re-routed audio portion and return a result of analysis of the sample to determine whether the selected one or more telephone calls is a scam telephone call.

2. The system according to claim 1, wherein the fraud detection system is configured to sample the re-routed audio portion of the selected one or more telephone calls from the originating entity for a selected time period to extract a sample from the re-routed audio portion.

3. The system according to claim 2, wherein the selected time period is selected so as to be sufficient to gather a context of the telephone call.

4. The system according to claim 2, wherein the selected time period is at least a portion of a total duration of the telephone call and is between half of a minute to 4 minutes.

5. The system according to claim 1, wherein the fraud detection system is configured to transcribe to text at least a portion of the sample from the re-routed audio portion.

6. The system according to claim 1, wherein the fraud detection system is an integral part of the switch platform.

7. The system according to claim 1, wherein a number of the plurality of telephone call exceeds a thousand of telephone calls per second.

8. The system according to claim 1, wherein a signaling of a telephone call in the selected one or more telephone calls remains within the switching platform.

9. The system according to claim 1, wherein the fraud detection system is configured to not sample an audio portion of the selected one or more telephone calls from the recipient of the telephone call.

10. The system according to claim 1, wherein the artificial intelligence engine is an integral part of the fraud detection system.

11. The system according to claim 1, wherein the artificial intelligence engine uses a machine learning algorithm to analyze a text portion of the re-routed audio portion and determine whether the selected one or more telephone calls is a scam telephone call.

12. The system according to claim 11, wherein the machine learning algorithm includes a large language model.

13. The system according to claim 1, wherein the artificial intelligence engine is configured to return the result of the analysis to the fraud detection system.

14. A method of detecting scams in telephone communications comprising:
routing a telephone call, using a switch platform, from an originating entity to a receiving entity, the switch platform being in communication with the originating entity as an originator of the telephone call and the receiving entity as a recipient of the telephone, the switch platform being configured to receive a plurality of telephone calls:
receiving, by a fraud detection system in communication with the switch platform, a re-routed audio portion of selected one or more telephone calls from the plurality of telephone calls;
analyzing, by an artificial intelligence engine in communication with the fraud detection system, a sample of the re-routed audio portion; and
returning, by the artificial intelligence engine to the fraud detection system, a result of analysis of the sample of the re-routed audio portion determining whether the selected one or more telephone calls is a scam telephone call.

15. The method according to claim 14, further comprising:
sampling, by the fraud detection system, the re-routed audio portion of the selected one or more telephone calls from the originator of the telephone call for a selected time period; and
extracting, by the fraud detection system, a sample from the re-routed audio portion.

16. The method according to claim 15, wherein the selected time period is selected so as to be sufficient to gather a context of the telephone call.

17. The method according to claim 14, further comprising:
transcribing, by the fraud detection system, to text at least a portion of the sample from the re-routed audio portion.

18. The method according to claim 14, further comprising:
not sampling, by the fraud detection system, an audio portion of the selected one or more telephone calls from the recipient of the telephone call.

19. The method according to claim 14, further comprising:
analyzing, by the artificial intelligence engine using a machine learning algorithm, a text portion of the re-routed audio portion; and
determining, by the artificial intelligence engine using the machine learning algorithm, whether the selected one or more telephone calls is a scam telephone call.
